(19) United States
(12) Patent Application Publication
(10) Pub. No.: US 2024/0163942 A1
(43) Pub. Date: May 16, 2024

(54) APPARATUS, SYSTEM, AND METHOD OF CONDITIONED COMMUNICATION OVER A MILLIMETER WAVE (MMWAVE) LINK

(71) Applicants: Laurent Cariou, Milizac (FR); Thomas Kenney, Portland, OR (US)

(72) Inventors: Laurent Cariou, Milizac (FR); Thomas Kenney, Portland, OR (US)

(21) Appl. No.: 18/399,408

(22) Filed: Dec. 28, 2023

(51) Int. Cl. H04W 76/15

(52) U.S. Cl. CPC H04W 76/15

(57) ABSTRACT

For example, a non Access Point (AP) (non-AP) Multi-Link Device (MLD) may be configured to set at least one millimeter Wave (mmWave) link usage condition field to indicate mmWave link usage condition information for Multi-Link (ML) Operation (MLO) over an mmWave link and a sub 10 Gigahertz (GHz) (sub-10 GHz) link with an AP MLD. For example, the mmWave link usage condition information may be configured to indicate one or more conditions for the AP MLD to use the mmWave link to transmit one or more transmissions to the non-AP MLD. For example, the non-AP MLD may be configured to transmit a frame, which includes the at least one mmWave link usage condition field, for example, to the AP MLD.

### BACKGROUND

Devices in a wireless communication system may be configured to communicate over a millimeter Wave (mmWave) wireless communication channel.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic flow-chart illustration of a method of conditioned communication over a millimeter Wave (mmWave) link, in accordance with some demonstrative aspects.

FIG. 5 is a schematic flow-chart illustration of a method of conditioned communication over an mmWave link, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D5.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), November 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a sub-7 GHz frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 40 GHz, for example, a frequency band above 45 GHz, e.g., a 60 GHz frequency band, a frequency band between 42.5 GHz and 71 GHz, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

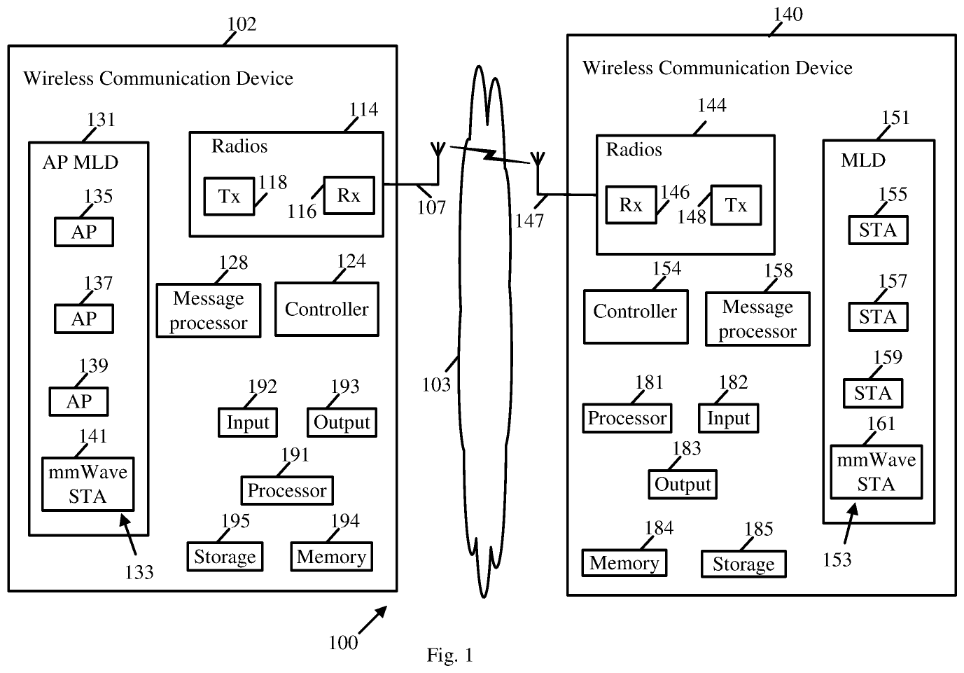

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102, and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, one or more channels in a sub-7 GHz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in an mmWave wireless communication frequency band, for example, one or more channels in a frequency band above 40 GHz, for example, one or more channels in a frequency band above 45 GHz, e.g., one or more channels in a 60 GHz frequency band, one or more channels in a frequency band between 42.5 GHz and 71 GHz, and/or one or more channels in any other mmWave frequency band.

In other aspects, WM 103 may include any other type of channel over any other frequency band.

In some demonstrative aspects, device 102 and/or device 140 may include one or more radios including circuitry and/or logic to perform wireless communication between devices 102, 140, and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 GHz band, for example, a sub-7 GHz band, for example, a 2.4 GHz band, a 5 GHz band, a 6 GHz band, and/or any other sub-10 GHz and/or sub-7 GHz band; and/or an mmWave band, e.g., a 45 GHz band, a 60 GHz band, a band between 42.5 GHz and 71 GHz, and/or any other mmWave band; and/or any other band, e.g., a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102 and/or device 140 may be configured to perform one or more operations, and/or functionalities of a WiFi 8 STA.

In other aspects, for example, devices 102 and/or 140 may be configured to perform one or more operations, and/or functionalities of an Ultra High Reliability (UHR) STA.

In other aspects, for example, devices 102 and/or 140 may be configured to perform one or more operations, and/or functionalities of an Integrated mmWave (IMMW) STA.

In other aspects, for example, devices 102 and/or 140 may be configured to perform one or more operations, and/or functionalities of any other additional or alternative type of STA.

In other aspects, devices 102, and/or 140 may include, operate as, perform the role of, and/or perform one or more functionalities of, any other wireless device and/or station, e.g., a WLAN STA, a WiFi STA, and the like.

In some demonstrative aspects, device 102 and/or device 140 may be configured to operate as, perform the role of, and/or perform one or more functionalities of, an access point (AP), e.g., an EHT AP STA, a UHR AP STA, and/or an IMMW AP STA.

In some demonstrative aspects, device 102 and/or device 140 may be configured to operate as, perform the role of, and/or perform one or more functionalities of, a non-AP STA, e.g., an EHT non-AP STA, a UHR non-AP STA, and/or an IMMW non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, a UHR network, an IMMW network, and/or any other network.

In some demonstrative aspects, devices 102, 140 and/or 150 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, perform and/or to trigger, cause, instruct and/or control device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, an mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 40 GHz, for example, a frequency band above 45 GHz, e.g., a 60 GHz frequency band, a frequency band between 42.5 GHz and 71 GHz, and/or any other mmWave frequency band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects controller 124 may be configured to control, perform and/or to trigger, cause, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, perform and/or to trigger, cause, instruct and/or control device 140 to operate as, perform a role of, and/or perform one or more operations and/or functionalities of, an MLD 151 including a plurality of STAs 153, e.g., including a STA 155, a STA 157, a STA 159, and/or a STA 161. In some aspects, as shown in FIG. 1, MLD 151 may include four STAs. In other aspects, MLD 151 may include any other number of STAs.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, for example, the one or more radios 144 may include, for example, a radio for communication by mmWave STA 161 over a fourth wireless communication frequency channel and/or frequency band, e.g., an mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, perform and/or to trigger, cause, instruct and/or control MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, perform and/or to trigger, cause, instruct and/or control MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects controller 154 may be configured to control, perform and/or to trigger, cause, instruct and/or control device 140 to operate as, perform a role of, and/or perform one or more operations and/or functionalities of, any other additional or alternative entity and/or STA, e.g., a single STA, multiple STAs, and/or a non-MLD entity.

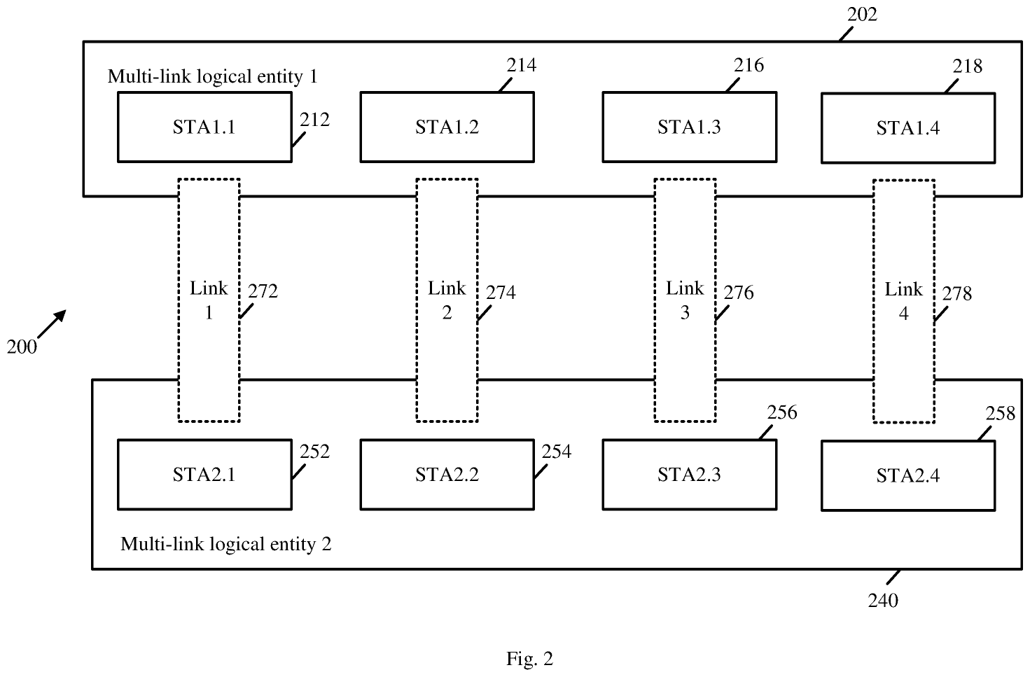

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

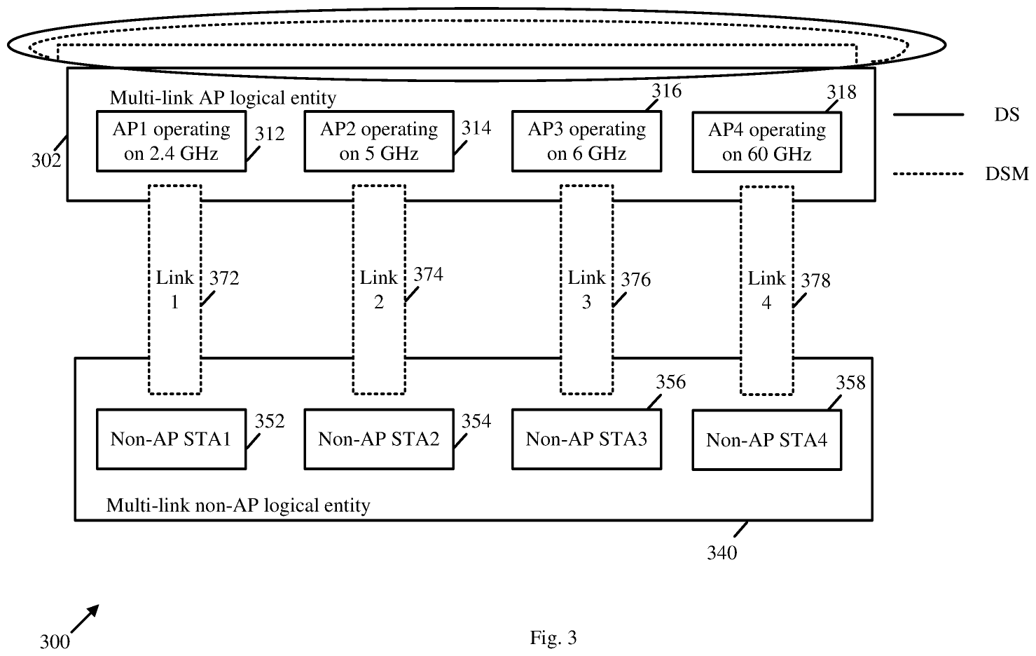

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, AP STA 316 may be configured to communicate over a 6 GHz frequency band, and/or mmWave STA 318 may be configured to communicate over an mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to implement one or more operations and/or functionalities of a Multi-Link Operation (MLO) mechanism, which may be configured to support wireless communication over an mmWave link, e.g., as described below.

In some demonstrative aspects, device 102 and/or device 140 may be configured to implement one or more operations and/or functionalities of an MLO mechanism, which may be configured to provide a technical solution to support mmWave operation, e.g., operation at an mmWave band, together with, a sub-10 GHz functionality, for example, according to a suitable mainstream Wi-Fi protocol, e.g., as described below.

In some demonstrative aspects, device 102 and/or device 140 may be configured to implement one or more operations and/or functionalities of an MLO mechanism, which may be configured to provide a technical solution to support reuse of at least some components of, e.g., as much as possible of, the same baseband, for communications by both a sub-10 GHz radio, e.g., a regular Wi-Fi radio, and an mmWave radio, e.g., a 60 GHz radio, e.g., as described below.

In some demonstrative aspects, device 102 and/or device 140 may be configured to implement one or more operations and/or functionalities of an MLO mechanism, which may be configured based on, and/or may utilize, a multi-link framework, for example, according to an MLD architecture, e.g., as described above.

In some demonstrative aspects, device 102 and/or device 140 may be configured to implement one or more operations and/or functionalities of an MLO mechanism, which may be configured to provide a technical solution to support an Integrated mmWave (IMMW) technology, for example, to define a WiFi interface for communication over an mmWave band, e.g., as described below.

For example, the IMMW technology may be configured to provide a technical solution to reduce complexity, e.g., as low complexity as possible, for example, by reusing in the mmWave band at least some, e.g., most, of a PHY PPDU structure and/or a PHY procedure as in a lower band, e.g., the sub-10 GHz band.

For example, it may be defined, e.g., according to the IMMW technology, that a device may not be allowed to operate as an mmWave-only device.

For example, it may be defined, e.g., according to the IMMW technology, that an IMMW device, e.g., an IMMW STA, may be configured to support the use of an mmWave link in the mmWave band, for example, together with a sub-10 GHz link in the sub-10 GHz band, e.g., in the lower bands of 2.4 GHz, 5 GHz, and/or 6 GHz.

For example, it may be defined, e.g., according to the IMMW technology, that an IMMW device, e.g., an IMMW STA, may be configured to support Multi-Link Operation (MLO), e.g., in accordance with an IEEE 802.11be Specification.

For example, it may be defined, e.g., according to the IMMW technology, that an IMMW device, e.g., an IMMW STA, may be configured to utilize the MLO, for example, to provide a technical solution to support significant reduction in complexity of an mmWave interface, for example, by using a link in a lower band, e.g., a sub-10 GHz link, to support the mmWave link.

For example, it may be defined, e.g., according to the IMMW technology, that an IMMW device, e.g., an IMMW STA, may be configured to utilize communications over the sub-10 GHz band, for example, for discovery, association, broadcast transmissions, or the like.

For example, it may be defined, e.g., according to the IMMW technology, that an IMMW device, e.g., an IMMW STA, may be configured to selectively restrict communications over the mmWave band based on one or more restrictions and/or conditions.

For example, it may be defined, e.g., according to the IMMW technology, that an IMMW device, e.g., an IMMW STA, may be configured to only use the mmWave link, e.g., when needed for data transmissions.

In some demonstrative aspects, device 102 and/or device 140 may be configured to implement one or more operations and/or functionalities of an MLO mechanism, which may be configured to support reduced power consumption for communication in an mmWave band. For example, the power consumption for communication in the mmWave band may be higher than a power consumption for communication in a lower band, e.g., a sub-10 GHz band.

For example, the power consumption in the mmWave band may be reduced, for example, by limiting a listen time in the mmWave band, for example, by only waking up the mmWave link when really needed.

In some demonstrative aspects, device 102 and/or device 140 may be configured to implement one or more operations and/or functionalities of an MLO mechanism, which may be configured to provide a technical solution to support reduced power consumption for communication over an mmWave link, e.g., as described below.

In some demonstrative aspects, the MLO mechanism may be configured to define a way for a non-AP MLD to indicate to its associated AP MLD a policy for how the AP MLD may, e.g., will, use the mmWave link, e.g., as described below.

In some demonstrative aspects, the policy for how the AP MLD may use the mmWave link may be configured to define one or more restrictions and/or conditions, which may selectively restrict communications over the mmWave link between the non-AP MLD and its associated AP MLD, e.g., as described below.

In some demonstrative aspects, the MLO mechanism may be configured to support communication between an AP MLD and a non-AP MLD associated with the AP MLD, for example, using at least one link in the sub-10 GHz band, e.g., a 2.4 GHz band, a 5 GHz band, and/or a 6 GHz band, and at least one link in the mmWave band, e.g., as described below.

In some demonstrative aspects, device 102 and/or device 140 may be configured to implement one or more operations and/or functionalities of an MLO mechanism, which may be configured to allow the non-AP MLD to indicate one or more conditions for the AP MLD to use the mmWave link, for example, to transmit one or more transmissions to the non-AP MLD, e.g., as described below.

In some demonstrative aspects, the one or more conditions for the AP MLD to use the mmWave link may be, for example, based on and/or may take into consideration, for example, a power consumption for communication over the mmWave link, e.g., as described below.

In some demonstrative aspects, device 102 and/or device 140 may be configured to implement one or more operations and/or functionalities of an MLO mechanism, which may be configured to allow a non-AP MLD to transmit to an AP MLD mmWave usage condition information (also referred to as a “mmWave usage policy” or “mmWave usage policy information”), which may define one or more conditions and/or restrictions for using the mmWave link, e.g., as described below.

In some demonstrative aspects, the non-AP MLD may transmit the mmWave usage condition information, for example, in an mmWave usage policy Information Element (IE), and/or in a mmWave usage policy frame, e.g., as described below.

In other aspects, the non-AP MLD may transmit the mmWave usage condition information as part of any other additional or alternative type of frame and/or element.

In some demonstrative aspects, controller 154 may be configured to control, trigger, cause, and/or instruct a non-AP MLD implemented by device 140 to set at least one mmWave link usage condition field to indicate mmWave link usage condition information for MLO over an mmWave link and a sub-10 GHz link with an AP MLD, e.g., as described below.

In some demonstrative aspects, the mmWave link usage condition information may be configured to indicate one or more conditions for the AP MLD to use the mmWave link to transmit one or more transmissions to the non-AP MLD, e.g., as described below.

In some demonstrative aspects, controller 154 may be configured to control, trigger, cause, and/or instruct the non-AP MLD implemented by device 140 to transmit a frame, which includes the at least one mmWave link usage condition field, for example, to the AP MLD, e.g., as described below.

In some demonstrative aspects, the mmWave link usage condition information may be configured to restrict usage of the mmWave link by the AP MLD, for example, according to the one or more conditions, e.g., as described below.

In some demonstrative aspects, the mmWave link usage condition information may be configured to prohibit the usage of the mmWave link by the AP MLD for one or more unallowed transmissions, which are not allowed, for example, according to the one or more conditions, e.g., as described below.

In some demonstrative aspects, the at least one mmWave link usage condition field may be configured to indicate that the AP MLD is not allowed to transmit over the mmWave link any frame transmissions to the non-AP MLD, which do not meet any of the one or more conditions, for example, according to the mmWave link usage condition information, or any predefined exception, e.g., as described below.

In some demonstrative aspects, controller 124 may be configured to control, trigger, cause, and/or instruct an AP MLD implemented by device 102 to process at least one mmWave link usage condition field in a frame from a non-AP MLD, for example, to identify mmWave link usage condition information for MLO over an mmWave link and a sub-10 GHz link with the non-AP MLD, e.g., as described below.

In some demonstrative aspects, the mmWave link usage condition information may be configured to indicate one or more conditions for the AP MLD to use the mmWave link to transmit one or more transmissions to the non-AP MLD, e.g., as described below.

For example, the received frame, which is received by the AP MLD implemented by device 102, may include the frame transmitted from the non-AP MLD implemented by device 140.

In some demonstrative aspects, controller 124 may be configured to control, trigger, cause, and/or instruct the AP MLD implemented by device 102 to restrict usage of the mmWave link by the AP MLD, for example, according to the one or more conditions received from the non-AP MLD, e.g., as described below.

In some demonstrative aspects, controller 124 may be configured to control, trigger, cause, and/or instruct the AP MLD implemented by device 102 to prohibit the usage of the mmWave link by the AP MLD for one or more unallowed transmissions, which are not allowed, for example, according to the one or more conditions received from the non-AP MLD, e.g., as described below.

In some demonstrative aspects, controller 124 may be configured to control, trigger, cause, and/or instruct the AP MLD implemented by device 102 to prohibit the AP MLD from transmitting over the mmWave link any frame transmissions to the non-AP MLD, which do not meet any of the one or more conditions, for example, according to the mmWave link usage condition information received from the non-AP MLD, or any predefined exception, e.g., as described below.

In some demonstrative aspects, the sub-10 GHz link may include a sub-7 GHz link over a sub-7 GHz frequency band.

In other aspects, the sub-10 GHz link may include any other link in the sub-10 GHz frequency band.

In some demonstrative aspects, the mmWave link may include a link over a channel having a frequency above 40 GHz.

In some demonstrative aspects, the mmWave link may include a link over a channel in a frequency band between 42.5 GHz and 71 GHz.

In other aspects, the mmWave link may include a link over any other channel having frequency above 40 GHz.

In some demonstrative aspects, the mmWave frequency band may include a frequency band between 42.5 GHz and 71 GHz.

In other aspects, the mmWave frequency band may include any other suitable mmWave frequency band.

In some demonstrative aspects, the at least one mmWave link usage condition field may be configured to include a minimal PPDU size field, for example, to indicate that the AP MLD is to be allowed to transmit over the mmWave link one or more PPDUs having a PPDU size equal to or greater than a minimal PPDU size value in the minimal PPDU size field, e.g., as described below.

In some demonstrative aspects, the minimal PPDU size field may be configured to prohibit the AP MLD from transmitting over the mmWave link PPDUs having a PPDU size less than the minimal PPDU size value in the minimal PPDU size field.

For example, controller 124 may be configured to control, trigger, cause, and/or instruct the AP MLD implemented by device 102 to prohibit the AP MLD from transmitting over the mmWave link PPDUs having a PPDU size less than the minimal PPDU size value in the minimal PPDU size field.

In some demonstrative aspects, the at least one mmWave link usage condition field may include a minimal burst size field, for example, to indicate that the AP MLD is to be allowed to transmit over the mmWave link one or more PPDUs of a burst having a size equal to or greater than a minimal burst size value in the minimal burst size field, e.g., as described below.

In some demonstrative aspects, the minimal burst size field may be configured to prohibit the AP MLD from transmitting over the mmWave link PPDUs of bursts having a size less than the minimal burst size value in the minimal burst size field.

For example, controller 124 may be configured to control, trigger, cause, and/or instruct the AP MLD implemented by device 102 to prohibit the AP MLD from transmitting over the mmWave link PPDUs of bursts having a size less than the minimal burst size value in the minimal burst size field.

In some demonstrative aspects, the at least one mmWave link usage condition field may include a minimal latency bound field, for example, to indicate that the AP MLD is to be allowed to transmit over the mmWave link one or more MPDUs of a burst having a latency bound requirement equal to or lower than a minimal latency bound value in the minimal latency bound field, e.g., as described below.

In some demonstrative aspects, the minimal latency bound field may be configured to prohibit the AP MLD from transmitting over the mmWave link MPDUs of bursts having a latency bound requirement greater than the minimal latency bound value in the minimal latency bound field.

For example, controller 124 may be configured to control, trigger, cause, and/or instruct the AP MLD implemented by device 102 to prohibit the AP MLD from transmitting over the mmWave link MPDUs of bursts having a latency bound requirement greater than the minimal latency bound value in the minimal latency bound field.

In some demonstrative aspects, the at least one mmWave link usage condition field may include an allowed Access Category (AC) field, for example, to indicate that the AP MLD is to be allowed to transmit over the mmWave link one or more frames mapped to, or aggregated with, one or more ACs identified by the allowed AC field, e.g., as described below.

In some demonstrative aspects, the allowed AC field may be configured to prohibit the AP MLD from transmitting over the mmWave link frames, which are not mapped to, or aggregated with, the one or more ACs identified by the allowed AC field.

For example, controller 124 may be configured to control, trigger, cause, and/or instruct the AP MLD implemented by device 102 to prohibit the AP MLD from transmitting over the mmWave link frames, which are not mapped to, or aggregated with, the one or more ACs identified by the allowed AC field.

In some demonstrative aspects, the at least one mmWave link usage condition field may include a data frame limitation field, for example, to indicate that the AP MLD is to be restricted to transmit over the mmWave link only data frames, e.g., as described below.

In some demonstrative aspects, the data frame limitation field may be configured to indicate that the AP MLD is to be restricted to transmit over the mmWave link only data frames or non-data frames, which comply with one or more exceptions, e.g., as described below.

In some demonstrative aspects, the non-data frames, which comply with the one or more exceptions, may include a frame to assist a data transmission, e.g., as described below.

In some demonstrative aspects, the non-data frames, which comply with the one or more exceptions, may include a frame aggregated with a data frame, e.g., as described below.

In other aspects, the non-data frames, which comply with the one or more exceptions, may include any other type of frame, e.g., according to any other additional or alternative exception.

In some demonstrative aspects, the at least one mmWave link usage condition field may include an individual Target Wake Time (TWT) (iTWT) field, for example, to indicate that the AP MLD is to be allowed to transmit over the mmWave link, for example, after establishment of an iTWT between the AP MLD and the non-AP MLD over the mmWave link, e.g., as described below.

In some demonstrative aspects, the iTWT field may be configured to prohibit the AP MLD from transmitting over the mmWave link prior to establishment of the iTWT between the AP MLD and the non-AP MLD over the mmWave link.

For example, controller 124 may be configured to control, trigger, cause, and/or instruct the AP MLD implemented by device 102 to prohibit the AP MLD from transmitting over the mmWave link, for example, prior to establishment of the iTWT between the AP MLD and the non-AP MLD over the mmWave link.

In some demonstrative aspects, the at least one mmWave link usage condition field may include a BW exceeded field, for example, to indicate that the AP MLD is to be allowed to transmit over the mmWave link a data transmission having a BW exceeding a BW available over the sub-10 GHz link, e.g., as described below.

In other aspects, the at least one mmWave link usage condition field may include any other suitable additional or alternative types of fields, e.g., according to any other additional or alternative conditions.

In some demonstrative aspects, controller 124 may be configured to control, trigger, cause, and/or instruct the AP MLD implemented by device 102 to transmit a response frame to the non-AP MLD, for example, to indicate an establishment of an agreement with the non-AP MLD, for example, based on the one or more conditions according to the mmWave link usage condition information, e.g., as described below.

In some demonstrative aspects, controller 154 may be configured to control, trigger, cause, and/or instruct the non-AP MLD implemented by device 140 to process the response frame from the AP MLD, for example, to identify an establishment of the agreement with the AP MLD, for example, based on the one or more conditions according to the mmWave link usage condition information, e.g., as described below.

In some demonstrative aspects, controller 154 may be configured to control, trigger, cause, and/or instruct the non-AP MLD implemented by device 140 to transmit to the AP MLD an update frame, which may include at least one updated mmWave link usage condition field, for example, to indicate updated mmWave link usage condition information for the MLO, e.g., as described below.

In some demonstrative aspects, controller 154 may be configured to control, trigger, cause, and/or instruct the non-AP MLD implemented by device 140 to process the update frame from the non-AP MLD, for example, to identify the updated mmWave link usage condition information for the MLO, e.g., as described below.

In some demonstrative aspects, controller 154 may be configured to control, trigger, cause, and/or instruct the non-AP MLD implemented by device 140 to transmit to the AP MLD a teardown frame, for example, to cancel the one or more conditions according to the mmWave link usage condition information, e.g., as described below.

In some demonstrative aspects, controller 124 may be configured to control, trigger, cause, and/or instruct the AP MLD implemented by device 102 to cancel the one or more conditions according to the mmWave link usage condition information, for example, based on a teardown frame from the non-AP MLD, e.g., as described below.

In some demonstrative aspects, the at least one mmWave link usage condition field may be included in a mmWave usage policy IE, e.g., as described below.

In some demonstrative aspects, controller 154 may be configured to control, trigger, cause, and/or instruct the non-AP MLD implemented by device 140 to transmit to the AP MLD a frame including an mmWave usage policy IE, e.g., as described below.

In some demonstrative aspects, the mmWave usage policy IE may include the at least one mmWave link usage condition field, e.g., as described below.

In some demonstrative aspects, controller 124 may be configured to control, trigger, cause, and/or instruct the AP MLD implemented by device 102 to process the frame to identify the at least one mmWave link usage condition field in the mmWave usage policy IE, e.g., as described below.

In some demonstrative aspects, controller 154 may be configured to control, trigger, cause, and/or instruct the non-AP MLD implemented by device 140 to transmit the at least one mmWave link usage condition field in an association request frame or a reassociation request frame to the AP MLD, e.g., as described below.

In some demonstrative aspects, controller 124 may be configured to control, trigger, cause, and/or instruct the AP MLD implemented by device 102 to transmit a response frame, e.g., an association response frame or a reassociation response frame, to the non-AP MLD, for example, in response to the association request frame or the reassociation request frame.

In some demonstrative aspects, the response frame may be configured, for example, to indicate an establishment of an agreement with the non-AP MLD, for example, based on the one or more conditions according to the mmWave link usage condition information, e.g., as described below.

In other aspects, controller 154 may be configured to control, trigger, cause, and/or instruct the non-AP MLD implemented by device 140 to transmit the at least one mmWave link usage condition field in any other type of frame.

In other aspects, controller 124 may be configured to control, trigger, cause, and/or instruct the AP MLD implemented by device 102 to transmit the response frame as any other type of frame.

In some demonstrative aspects, controller 154 may be configured to control, trigger, cause, and/or instruct the non-AP MLD implemented by device 140 to process the response frame from the AP MLD to identify an establishment of an agreement with the AP MLD, for example, based on the one or more conditions according to the mmWave link usage condition information, e.g., as described below.

In some demonstrative aspects, the at least one mmWave link usage condition field may be included in a mmWave usage policy frame, e.g., as described below.

In some demonstrative aspects, controller 154 may be configured to control, trigger, cause, and/or instruct the non-AP MLD implemented by device 140 to transmit to the AP MLD an mmWave policy request frame including the at least one mmWave link usage condition field, e.g., as described below.

In some demonstrative aspects, controller 124 may be configured to control, trigger, cause, and/or instruct the AP MLD implemented by device 102 to transmit an mmWave policy response frame to the non-AP MLD, for example, to indicate an establishment of an agreement with the non-AP MLD, for example, based on the one or more conditions according to the mmWave link usage condition information, e.g., as described below.

In some demonstrative aspects, controller 154 may be configured to control, trigger, cause, and/or instruct the non-AP MLD implemented by device 140 to process the mmWave policy response frame from the AP MLD, for example, to identify an establishment of an agreement with the AP MLD, for example, based on the one or more conditions according to the mmWave link usage condition information, e.g., as described below.

In some demonstrative aspects, device 102 and/or device 140 may be configured to implement one or more operations and/or functionalities of an MLO mechanism, which may be configured to support conditioned communication over an mmWave link, e.g., as described below.

In some demonstrative aspects, the conditioned communication over the mmWave link may be implemented, for example, to provide a technical solution to support reduced power consumption for communication over the mmWave link, for example, by limiting a communication time over the mmWave link, e.g., as described below.

For example, a non-AP MLD may be associated with an AP MLD over at least one link in the sub-10 GHz band, e.g., a 2.4 GHz band, a 5 GHz band, and/or a 6 GHz band, and at least one link in the mmWave band, e.g., as described above.

For example, the non-AP MLD, e.g., the AP MLD implemented by device 140, may be allowed to indicate to the AP MLD, e.g., the AP MLD implemented by device 102, how the non-AP MLD wants to use the mmWave link, for example, with an expectation that use of the mmWave link may take into consideration a the power consumption during communication over the mmWave link.

In some demonstrative aspects, device 102 and/or device 140 may be configured to implement one or more operations and/or functionalities of an MLO mechanism, which may define mmWave usage policy information, which may be communicated, for example, in a mmWave usage policy IE, or in a mmWave usage policy frame, e.g., as described below.

In some demonstrative aspects, a non-AP MLD, e.g., a non-AP MLD implemented by device 140, may be allowed to transmit the mmWave usage policy information to an AP MLD, e.g., an AP MLD implemented by device 102.

In some demonstrative aspects, the mmWave usage policy information may be included in an element, which may include one or more fields, for example, mmWave link usage condition fields, which may be configured to indicate one or more conditions for communication over the mmWave link between the AP MLD and the non-AP MLD, e.g., as described below.

In some demonstrative aspects, it may be defined that the mmWave usage policy information may be communicated, for example, in a mmWave usage policy IE, or in a mmWave usage policy frame, for example, in a minimal PPDU size field, which may be configured, for example, to indicate that only a PPDU size larger than indicated in this field may be, e.g., shall be, transmitted on the mmWave link between the AP MLD and the non-AP MLD.

In some demonstrative aspects, it may be defined that the mmWave usage policy information may be communicated, for example, in a mmWave usage policy IE, or in a mmWave usage policy frame, for example, in a minimal burst size field, which may be configured, for example, to indicate that only PPDUs corresponding to a burst that is larger than the value carried in that field can be scheduled for transmission on the mmWave link between the AP MLD and the non-AP MLD.

In some demonstrative aspects, it may be defined that the mmWave usage policy information may be communicated, for example, in a mmWave usage policy IE, or in a mmWave usage policy frame, for example, in a minimal latency bound field, which may be configured, for example, to indicate that only MPDUs that have a latency bound requirement that is lower than a certain threshold can be transmitted on the mmWave link between the AP MLD and the non-AP MLD.

In some demonstrative aspects, it may be defined that the mmWave usage policy information may be communicated, for example, in a mmWave usage policy IE, or in a mmWave usage policy frame, for example, in an AC allowed field, which may be configured, for example, to indicate that only frames mapped to the indicated ACs are allowed to be transmitted on the mmWave link between the AP MLD and the non-AP MLD, for example, with exception of frames not mapped to the indicated ACs but aggregated with frames mapped to the indicated ACs. In other aspects, any other additional or alternative exception may be defined.

In some demonstrative aspects, it may be defined that the mmWave usage policy information may be communicated, for example, in a mmWave usage policy IE, or in a mmWave usage policy frame, for example, in a data frame limitation field, e.g., data frames only field, which may be configured, for example, to indicate that only data frames can be transmitted on the mmWave link between the AP MLD and the non-AP MLD.

In some demonstrative aspects, one or more exceptions be defined, for example, to allow transmission of non-data frames, which comply with the one or more exceptions.

In one example, it may be defined that the frames only field, when used, may allow transmission of non-data frames over the mmWave link, for example, if the non-data frames are needed to assist data transmissions. In one example, this exception may permit the communication of non-data frames used for beamforming training.

In another example, it may be defined that the frames only field, when used, may allow transmission of non-data frames over the mmWave link, for example, if the non-data frames are aggregated with the data frames meeting one or more conditions for transmission on the mmWave link between the AP MLD and the non-AP MLD.

In some demonstrative aspects, it may be defined that the mmWave usage policy information may be communicated, for example, in a mmWave usage policy IE, or in a mmWave usage policy frame, for example, in an iTWT field, which may be configured, for example, to indicate that data frames may only be transmitted on the mmWave link, for example, after an individual TWT agreement has been established between the AP MLD and the non-AP MLD on the mmWave link.

In some demonstrative aspects, it may be defined that the mmWave usage policy information may be communicated, for example, in a mmWave usage policy IE, or in a mmWave usage policy frame, for example, in a BW exceeded field, which may be configured, for example, to indicate that a data transmission over the mmWave link is permitted, for example, when bandwidth requirements for the data transmission exceed available resources in a lower band, e.g., a sub-10 GHz band.

In other aspects, it may be defined that the mmWave usage policy information may be communicated, for example, in a mmWave usage policy IE, or in a mmWave usage policy frame, for example, in any other additional or alternative fields to condition data transmission over the mmWave link between the AP MLD and the non-AP MLD.

In some demonstrative aspects, it may be defined that frame transmissions that are not meeting one, e.g., any one, of the above conditions defined in the one or more of mmWave link usage condition fields may be, e.g., shall be, transmitted in the lower band, e.g., the sub-10 GHz band.

In some demonstrative aspects, it may be defined that the mmWave usage policy information may be transmitted from the non-AP MLD, e.g., the non-AP MLD implemented by device 140, to the AP MLD, e.g., the AP MLD implemented by device 102, for example, during ML association between the non-AP MLD and the AP MLD.

In some demonstrative aspects, the non-AP MLD, e.g., the non-AP MLD implemented by device 140, may be configured to include the mmWave usage policy information in an association request frame or a reassociation request frame, which may be transmitted from the non-AP MLD to the AP MLD, for example, during ML association.

In some demonstrative aspects, it may be defined that, for example, in case of association, the mmWave usage policy may, e.g., shall, be respected by the AP MLD, for example, when the AP accepts the association of the mmWave link as part of the ML setup with an association response frame or a reassociation response frame.

In some demonstrative aspects, the non-AP MLD, e.g., the non-AP MLD implemented by device 140, may be configured to include the mmWave usage policy information in an mmWave policy request frame, which may be transmitted from the non-AP MLD to the AP MLD.

In some demonstrative aspects, it may be defined that, for example, in case the AP MLD receives the mmWave policy request frame, then the AP MLD may, e.g., shall, respond with a mmWave policy response frame, for example, with a successful response, for example, to establish the agreement for the mmWave usage policy. For example, it may be defined that the AP MLD shall respect the mmWave usage policy.

In other aspects, the mmWave usage policy information may be communicated as part of any other type of frame and/or procedure.

In some demonstrative aspects, the non-AP MLD may be allowed to update the mmWave policy, for example, by sending to the AP MLD a new mmWave policy request frame, which may contain a new mmWave policy.

In some demonstrative aspects, the non-AP MLD may be allowed to tear down the mmWave policy, for example, by sending an mmWave policy tear down frame.

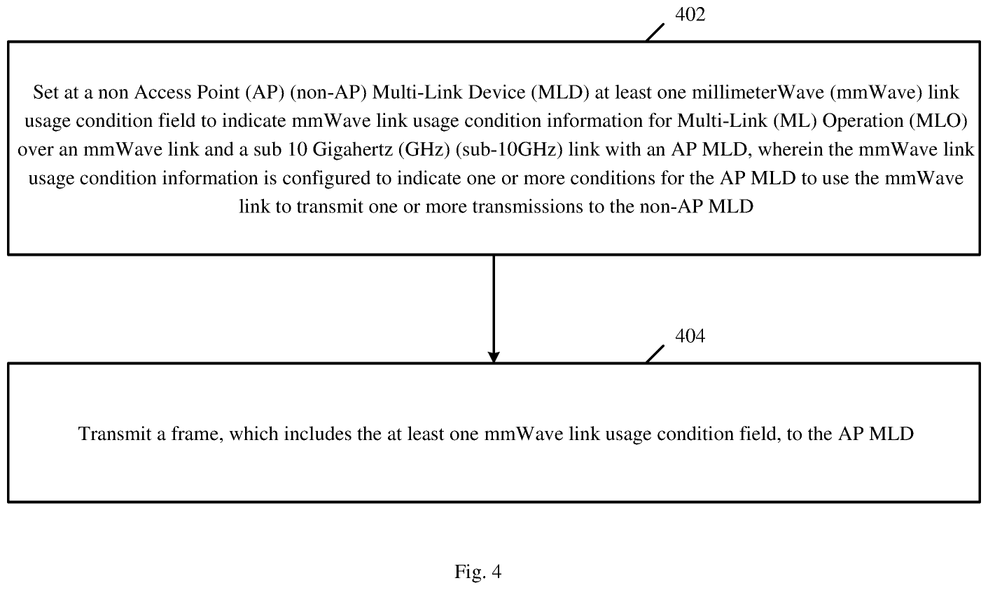

Reference is made to FIG. 4, which schematically illustrates a method of conditioned communication over an mmWave link, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include setting at a non-AP MLD at least one mmWave link usage condition field to indicate mmWave link usage condition information for MLO over an mmWave link and a sub-10 GHz link with an AP MLD. For example, the mmWave link usage condition information may be configured to indicate one or more conditions for the AP MLD to use the mmWave link to transmit one or more transmissions to the non-AP MLD. For example, controller 154 (FIG. 1) may be configured to cause, trigger, and/or control device 140 (FIG. 1) to set at least one mmWave link usage condition field to indicate mmWave link usage condition information for MLO over an mmWave link and a sub-10 GHz link with an AP MLD, for example, to indicate one or more conditions for the AP MLD to use the mmWave link to transmit one or more transmissions to the non-AP MLD, e.g., as described above.

As indicated at block 404, the method may include transmitting from the non-AP MLD to the AP MLD a frame including the at least one mmWave link usage condition field. For example, controller 154 (FIG. 1) may be configured to cause, trigger, and/or control device 140 (FIG. 1) to transmit to the AP MLD a frame, which includes the at least one mmWave link usage condition field, e.g., as described above.

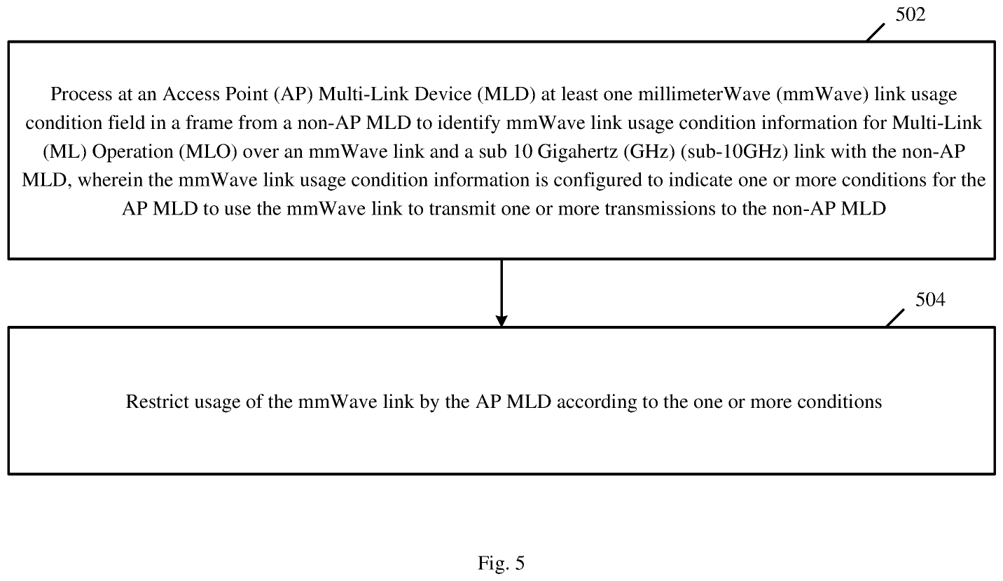

Reference is made to FIG. 5, which schematically illustrates a method of conditioned communication over an mmWave link, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include processing at an AP MLD at least one mmWave link usage condition field in a frame from a non-AP MLD to identify mmWave link usage condition information for MLO over an mmWave link and a sub-10 GHz link with the non-AP MLD. For example, the mmWave link usage condition information may be configured to indicate one or more conditions for the AP MLD to use the mmWave link to transmit one or more transmissions to the non-AP MLD. For example, controller 124 (FIG. 1) may be configured to cause, trigger, and/or control device 102 (FIG. 1) to process at least one mmWave link usage condition field in a frame from a non-AP MLD to identify mmWave link usage condition information for MLO over an mmWave link and a sub-10 GHz link with the non-AP MLD, for example, to identify one or more conditions for the AP MLD to use the mmWave link to transmit one or more transmissions to the non-AP MLD, e.g., as described above.

As indicated at block 504, the method may include restricting usage of the mmWave link by the AP MLD, for example, according to the one or more conditions. For example, controller 124 (FIG. 1) may be configured to cause, trigger, and/or control device 102 (FIG. 1) to restrict usage of the mmWave link by the AP MLD according to the one or more conditions, e.g., as described above.

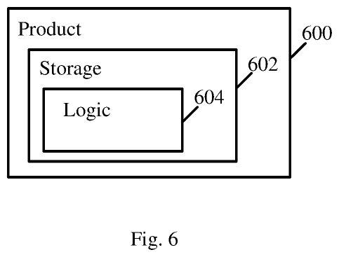

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1); to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities; and/or to perform, trigger and/or implement one or more operations and/or functionalities described with reference to the FIGS. 1, 2, 3, 4, and/or 5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a non Access Point (AP) (non-AP) Multi-Link Device (MLD) to set at least one millimeter Wave (mmWave) link usage condition field to indicate mmWave link usage condition information for Multi-Link (ML) Operation (MLO) over an mmWave link and a sub 10 Gigahertz (GHz) (sub-10 GHz) link with an AP MLD, wherein the mmWave link usage condition information is configured to indicate one or more conditions for the AP MLD to use the mmWave link to transmit one or more transmissions to the non-AP MLD; and transmit a frame to the AP MLD, the frame comprising the at least one mmWave link usage condition field.

Example 2 includes the subject matter of Example 1, and optionally, wherein the mmWave link usage condition information is configured to restrict usage of the mmWave link by the AP MLD according to the one or more conditions.

Example 3 includes the subject matter of Example 1 or 2, and optionally, wherein the mmWave link usage condition information is configured to prohibit the usage of the mmWave link by the AP MLD for one or more unallowed transmissions, which are not allowed according to the one or more conditions.

Example 4 includes the subject matter of any one of Examples 1-3, and optionally, wherein the at least one mmWave link usage condition field comprises a minimal Physical layer (PHY) Protocol Data Unit (PPDU) size field to indicate that the AP MLD is to be allowed to transmit over the mmWave link one or more PPDUs having a PPDU size equal to or greater than a minimal PPDU size value in the minimal PPDU size field.

Example 5 includes the subject matter of Example 4, and optionally, wherein the minimal PPDU size field is configured to prohibit the AP MLD from transmitting over the mmWave link PPDUs having a PPDU size less than the minimal PPDU size value in the minimal PPDU size field.

Example 6 includes the subject matter of any one of Examples 1-5, and optionally, wherein the at least one mmWave link usage condition field comprises a minimal burst size field to indicate that the AP MLD is to be allowed to transmit over the mmWave link one or more Physical layer (PHY) Protocol Data Units (PPDUs) of a burst having a size equal to or greater than a minimal burst size value in the minimal burst size field.

Example 7 includes the subject matter of Example 6, and optionally, wherein the minimal burst size field is configured to prohibit the AP MLD from transmitting over the mmWave link PPDUs of bursts having a size less than the minimal burst size value in the minimal burst size field.

Example 8 includes the subject matter of any one of Examples 1-7, and optionally, wherein the at least one mmWave link usage condition field comprises a minimal latency bound field to indicate that the AP MLD is to be allowed to transmit over the mmWave link one or more Medium Access Control (MAC) Protocol Data Units (MPDUs) of a burst having a latency bound requirement equal to or lower than a minimal latency bound value in the minimal latency bound field.

Example 9 includes the subject matter of Example 8, and optionally, wherein the minimal latency bound field is configured to prohibit the AP MLD from transmitting over the mmWave link MPDUs of bursts having a latency bound requirement greater than the minimal latency bound value in the minimal latency bound field.

Example 10 includes the subject matter of any one of Examples 1-9, and optionally, wherein the at least one mmWave link usage condition field comprises an allowed Access Category (AC) field to indicate that the AP MLD is to be allowed to transmit over the mmWave link one or more frames mapped to, or aggregated with, one or more ACs identified by the allowed AC field.

Example 11 includes the subject matter of Example 10, and optionally, wherein the allowed AC field is configured to prohibit the AP MLD from transmitting over the mmWave link frames, which are not mapped to, or aggregated with, the one or more ACs identified by the allowed AC field.

Example 12 includes the subject matter of any one of Examples 1-11, and optionally, wherein the at least one mmWave link usage condition field comprises a data frame limitation field to indicate that the AP MLD is to be restricted to transmit over the mmWave link only data frames.

Example 13 includes the subject matter of any one of Examples 1-12, and optionally, wherein the at least one mmWave link usage condition field comprises a data frame limitation field to indicate that the AP MLD is to be restricted to transmit over the mmWave link only data frames or non-data frames, which comply with one or more exceptions.

Example 14 includes the subject matter of Example 13, and optionally, wherein the non-data frames, which comply with the one or more exceptions, comprise at least one of a frame to assist a data transmission, or a frame aggregated with a data frame.

Example 15 includes the subject matter of any one of Examples 1-14, and optionally, wherein the at least one mmWave link usage condition field comprises an individual Target Wake Time (TWT) (iTWT) field to indicate that the AP MLD is to be allowed to transmit over the mmWave link after establishment of an iTWT between the AP MLD and the non-AP MLD over the mmWave link.

Example 16 includes the subject matter of Example 15, and optionally, wherein the iTWT field is configured to prohibit the AP MLD from transmitting over the mmWave link prior to establishment of the iTWT between the AP MLD and the non-AP MLD over the mmWave link.

Example 17 includes the subject matter of any one of Examples 1-16, and optionally, wherein the at least one mmWave link usage condition field comprises a Bandwidth (BW) exceeded field to indicate that the AP MLD is to be allowed to transmit over the mmWave link a data transmission having a BW exceeding a BW available over the sub-10 GHz link.

Example 18 includes the subject matter of any one of Examples 1-17, and optionally, wherein the at least one mmWave link usage condition field is configured to indicate that the AP MLD is not allowed to transmit over the mmWave link any frame transmissions to the non-AP MLD, which do not meet any of the one or more conditions according to the mmWave link usage condition information or any predefined exception.

Example 19 includes the subject matter of any one of Examples 1-18, and optionally, wherein the apparatus is configured to cause the non-AP MLD to process a response frame from the AP MLD to identify an establishment of an agreement with the AP MLD based on the one or more conditions according to the mmWave link usage condition information.

Example 20 includes the subject matter of any one of Examples 1-19, and optionally, wherein the apparatus is configured to cause the non-AP MLD to transmit to the AP MLD an update frame comprising at least one updated mmWave link usage condition field to indicate updated mmWave link usage condition information for the MLO.

Example 21 includes the subject matter of any one of Examples 1-20, and optionally, wherein the apparatus is configured to cause the non-AP MLD to transmit to the AP MLD a teardown frame to cancel the one or more conditions according to the mmWave link usage condition information.

Example 22 includes the subject matter of any one of Examples 1-21, and optionally, wherein the frame comprises an mmWave usage policy Information Element (IE), the mmWave usage policy IE comprising the at least one mmWave link usage condition field.

Example 23 includes the subject matter of any one of Examples 1-22, and optionally, wherein the frame comprises an association request frame or a reassociation request frame.

Example 24 includes the subject matter of Example 23, and optionally, wherein the apparatus is configured to cause the non-AP MLD to process a response frame from the AP MLD to identify an establishment of an agreement with the AP MLD based on the one or more conditions according to the mmWave link usage condition information, wherein the response frame comprises an association response frame or a reassociation response frame.

Example 25 includes the subject matter of any one of Examples 1-21, and optionally, wherein the frame comprises an mmWave policy request frame.

Example 26 includes the subject matter of Example 25, and optionally, wherein the apparatus is configured to cause the non-AP MLD to process an mmWave policy response frame from the AP MLD to identify an establishment of an agreement with the AP MLD based on the one or more conditions according to the mmWave link usage condition information.

Example 27 includes the subject matter of any one of Examples 1-26, and optionally, wherein the sub-10 GHz link comprises a sub-7 GHz link over a sub-7 GHz frequency band.

Example 28 includes the subject matter of any one of Examples 1-27, and optionally, wherein the mmWave link is over a channel having a frequency above 40 GHz.

Example 29 includes the subject matter of any one of Examples 1-28, and optionally, wherein the mmWave frequency band comprises a frequency band between 42.5 GHz and 71 GHz.

Example 30 includes the subject matter of any one of Examples 1-29, and optionally, comprising a radio to transmit the frame from the non-AP MLD.

Example 31 includes the subject matter of Example 30, and optionally, comprising one or more antennas connected to the radio, and a processor to execute instructions of an operating system of the non-AP MLD.

Example 32 includes an apparatus comprising logic and circuitry configured to cause an Access Point (AP) Multi-Link Device (MLD) to process at least one millimeter Wave (mmWave) link usage condition field in a frame from a non-AP MLD to identify mmWave link usage condition information for Multi-Link (ML) Operation (MLO) over an mmWave link and a sub 10 Gigahertz (GHz) (sub-10 GHz) link with the non-AP MLD, wherein the mmWave link usage condition information is configured to indicate one or more conditions for the AP MLD to use the mmWave link to transmit one or more transmissions to the non-AP MLD; and restrict usage of the mmWave link by the AP MLD according to the one or more conditions.

Example 33 includes the subject matter of Example 32, and optionally, wherein the apparatus is configured to cause the AP MLD to prohibit the usage of the mmWave link by the AP MLD for one or more unallowed transmissions, which are not allowed according to the one or more conditions.

Example 34 includes the subject matter of Example 32 or 33, and optionally, wherein the at least one mmWave link usage condition field comprises a minimal Physical layer (PHY) Protocol Data Unit (PPDU) size field to indicate that the AP MLD is to be allowed to transmit over the mmWave link one or more PPDUs having a PPDU size equal to or greater than a minimal PPDU size value in the minimal PPDU size field.

Example 35 includes the subject matter of Example 34, and optionally, wherein the apparatus is configured to prohibit the AP MLD from transmitting over the mmWave link PPDUs having a PPDU size less than the minimal PPDU size value in the minimal PPDU size field.

Example 36 includes the subject matter of any one of Examples 32-35, and optionally, wherein the at least one mmWave link usage condition field comprises a minimal burst size field to indicate that the AP MLD is to be allowed to transmit over the mmWave link one or more Physical layer (PHY) Protocol Data Units (PPDUs) of a burst having a size equal to or greater than a minimal burst size value in the minimal burst size field.

Example 37 includes the subject matter of Example 36, and optionally, wherein the apparatus is configured to prohibit the AP MLD from transmitting over the mmWave link PPDUs of bursts having a size less than the minimal burst size value in the minimal burst size field.

Example 38 includes the subject matter of any one of Examples 32-37, and optionally, wherein the at least one mmWave link usage condition field comprises a minimal latency bound field to indicate that the AP MLD is to be allowed to transmit over the mmWave link one or more Medium Access Control (MAC) Protocol Data Units (MPDUs) of a burst having a latency bound requirement equal to or lower than a minimal latency bound value in the minimal latency bound field.

Example 39 includes the subject matter of Example 38, and optionally, wherein the apparatus is configured to prohibit the AP MLD from transmitting over the mmWave link MPDUs of bursts having a latency bound requirement greater than the minimal latency bound value in the minimal latency bound field.

Example 40 includes the subject matter of any one of Examples 32-39, and optionally, wherein the at least one mmWave link usage condition field comprises an allowed Access Category (AC) field to indicate that the AP MLD is to be allowed to transmit over the mmWave link one or more frames mapped to, or aggregated with, one or more ACs identified by the allowed AC field.

Example 41 includes the subject matter of Example 40, and optionally, wherein the apparatus is configured to prohibit the AP MLD from transmitting over the mmWave link frames, which are not mapped to, or aggregated with, the one or more ACs identified by the allowed AC field.

Example 42 includes the subject matter of any one of Examples 32-41, and optionally, wherein the at least one mmWave link usage condition field comprises a data frame limitation field to indicate that the AP MLD is to be restricted to transmit over the mmWave link only data frames.

Example 43 includes the subject matter of any one of Examples 32-42, and optionally, wherein the at least one mmWave link usage condition field comprises a data frame limitation field to indicate that the AP MLD is to be restricted to transmit over the mmWave link only data frames or non-data frames, which comply with one or more exceptions.

Example 44 includes the subject matter of Example 43, and optionally, wherein the non-data frames, which comply with the one or more exceptions, comprise at least one of a frame to assist a data transmission, or a frame aggregated with a data frame.

Example 45 includes the subject matter of any one of Examples 32-44, and optionally, wherein the at least one mmWave link usage condition field comprises an individual Target Wake Time (TWT) (iTWT) field to indicate that the AP MLD is to be allowed to transmit over the mmWave link after establishment of an iTWT between the AP MLD and the non-AP MLD over the mmWave link.

Example 46 includes the subject matter of Example 45, and optionally, wherein the apparatus is configured to prohibit the AP MLD from transmitting over the mmWave link prior to establishment of the iTWT between the AP MLD and the non-AP MLD over the mmWave link.

Example 47 includes the subject matter of any one of Examples 32-46, and optionally, wherein the at least one mmWave link usage condition field comprises a Bandwidth (BW) exceeded field to indicate that the AP MLD is to be allowed to transmit over the mmWave link a data transmission having a BW exceeding a BW available over the sub-10 GHz link.

Example 48 includes the subject matter of any one of Examples 32-47, and optionally, wherein the apparatus is configured to prohibit the AP MLD from transmitting over the mmWave link any frame transmissions to the non-AP MLD, which do not meet any of the one or more conditions according to the mmWave link usage condition information or any predefined exception.

Example 49 includes the subject matter of any one of Examples 32-48, and optionally, wherein the apparatus is configured to cause the AP MLD to transmit a response frame to the non-AP MLD to indicate an establishment of an agreement with the non-AP MLD based on the one or more conditions according to the mmWave link usage condition information.

Example 50 includes the subject matter of any one of Examples 32-49, and optionally, wherein the apparatus is configured to cause the AP MLD to process an update frame from the non-AP MLD comprising at least one updated mmWave link usage condition field to identify updated mmWave link usage condition information for the MLO.

Example 51 includes the subject matter of any one of Examples 32-50, and optionally, wherein the apparatus is configured to cause the AP MLD to cancel the one or more conditions according to the mmWave link usage condition information based on a teardown frame from the non-AP MLD.

Example 52 includes the subject matter of any one of Examples 32-51, and optionally, wherein the frame from the non-AP MLD comprises an mmWave usage policy Information Element (IE), the mmWave usage policy IE comprising the at least one mmWave link usage condition field.

Example 53 includes the subject matter of any one of Examples 32-52, and optionally, wherein the frame from the non-AP MLD comprises an association request frame or a reassociation request frame.

Example 54 includes the subject matter of Example 53, and optionally, wherein the apparatus is configured to cause the AP MLD to transmit a response frame to the non-AP MLD to indicate an establishment of an agreement with the non-AP MLD based on the one or more conditions according to the mmWave link usage condition information, wherein the response frame comprises an association response frame or a reassociation response frame.

Example 55 includes the subject matter of any one of Examples 32-52, and optionally, wherein the frame from the non-AP MLD comprises an mmWave policy request frame.

Example 56 includes the subject matter of Example 55, and optionally, wherein the apparatus is configured to cause the AP MLD to transmit an mmWave policy response frame to the non-AP MLD to indicate an establishment of an agreement with the non-AP MLD based on the one or more conditions according to the mmWave link usage condition information.

Example 57 includes the subject matter of any one of Examples 32-56, and optionally, wherein the sub-10 GHz link comprises a sub-7 GHz link over a sub-7 GHz frequency band.

Example 58 includes the subject matter of any one of Examples 32-57, and optionally, wherein the mmWave link is over a channel having a frequency above 40 GHz.

Example 59 includes the subject matter of any one of Examples 32-58, and optionally, wherein the mmWave frequency band comprises a frequency band between 42.5 GHz and 71 GHz.

Example 60 includes the subject matter of any one of Examples 32-59, and optionally, comprising a radio to receive the frame from the non-AP MLD.

Example 61 includes the subject matter of Example 60, and optionally, comprising one or more antennas connected to the radio, and a processor to execute instructions of an operating system of the AP MLD.

Example 62 includes a wireless communication device comprising the apparatus of any of Examples 1-61.

Example 63 includes a mobile device comprising the apparatus of any of Examples 1-61.

Example 64 includes an apparatus comprising means for executing any of the described operations of any of Examples 1-61.

Example 65 includes a product comprising one or more tangible computer-readable non-transitory storage media comprising instructions operable to, when executed by at least one processor, enable the at least one processor to cause a wireless communication device to perform any of the described operations of any of Examples 1-61.

Example 66 includes an apparatus comprising: a memory interface; and processing circuitry configured to: perform any of the described operations of any of Examples 1-61.

Example 67 includes a method comprising any of the described operations of any of Examples 1-61.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a non Access Point (AP) (non-AP) Multi-Link Device (MLD) to:
set at least one millimeter Wave (mmWave) link usage condition field to indicate mmWave link usage condition information for Multi-Link (ML) Operation (MLO) over an mmWave link and a sub 10 Gigahertz (GHz) (sub-10 GHz) link with an AP MLD, wherein the mmWave link usage condition information is configured to indicate one or more conditions for the AP MLD to use the mmWave link to transmit one or more transmissions to the non-AP MLD; and
transmit a frame to the AP MLD, the frame comprising the at least one mmWave link usage condition field.

2. The apparatus of claim 1, wherein the mmWave link usage condition information is configured to restrict usage of the mmWave link by the AP MLD according to the one or more conditions.

3. The apparatus of claim 1, wherein the mmWave link usage condition information is configured to prohibit the usage of the mmWave link by the AP MLD for one or more unallowed transmissions, which are not allowed according to the one or more conditions.

4. The apparatus of claim 1, wherein the at least one mmWave link usage condition field comprises a minimal Physical layer (PHY) Protocol Data Unit (PPDU) size field to indicate that the AP MLD is to be allowed to transmit over the mmWave link one or more PPDUs having a PPDU size equal to or greater than a minimal PPDU size value in the minimal PPDU size field.

5. The apparatus of claim 1, wherein the at least one mmWave link usage condition field comprises a minimal burst size field to indicate that the AP MLD is to be allowed to transmit over the mmWave link one or more Physical layer (PHY) Protocol Data Units (PPDUs) of a burst having a size equal to or greater than a minimal burst size value in the minimal burst size field.

6. The apparatus of claim 1, wherein the at least one mmWave link usage condition field comprises a minimal latency bound field to indicate that the AP MLD is to be allowed to transmit over the mmWave link one or more Medium Access Control (MAC) Protocol Data Units (MPDUs) of a burst having a latency bound requirement equal to or lower than a minimal latency bound value in the minimal latency bound field.

7. The apparatus of claim 1, wherein the at least one mmWave link usage condition field comprises an allowed Access Category (AC) field to indicate that the AP MLD is to be allowed to transmit over the mmWave link one or more frames mapped to, or aggregated with, one or more ACs identified by the allowed AC field.

8. The apparatus of claim 1, wherein the at least one mmWave link usage condition field comprises a data frame limitation field to indicate that the AP MLD is to be restricted to transmit over the mmWave link only data frames or non-data frames, which comply with one or more exceptions.

9. The apparatus of claim 8, wherein the non-data frames, which comply with the one or more exceptions, comprise at least one of a frame to assist a data transmission, or a frame aggregated with a data frame.

10. The apparatus of claim 1, wherein the at least one mmWave link usage condition field comprises an individual Target Wake Time (TWT) (iTWT) field to indicate that the AP MLD is to be allowed to transmit over the mmWave link after establishment of an iTWT between the AP MLD and the non-AP MLD over the mmWave link.

11. The apparatus of claim 1, wherein the at least one mmWave link usage condition field comprises a Bandwidth (BW) exceeded field to indicate that the AP MLD is to be allowed to transmit over the mmWave link a data transmission having a BW exceeding a BW available over the sub-10 GHz link.

12. The apparatus of claim 1, wherein the at least one mmWave link usage condition field is configured to indicate that the AP MLD is not allowed to transmit over the mmWave link any frame transmissions to the non-AP MLD, which do not meet any of the one or more conditions according to the mmWave link usage condition information or any predefined exception.

13. The apparatus of claim 1 configured to cause the non-AP MLD to process a response frame from the AP MLD to identify an establishment of an agreement with the AP MLD based on the one or more conditions according to the mmWave link usage condition information.

14. The apparatus of claim 1 configured to cause the non-AP MLD to transmit to the AP MLD an update frame comprising at least one updated mmWave link usage condition field to indicate updated mmWave link usage condition information for the MLO.

15. The apparatus of claim 1, wherein the frame comprises an mmWave usage policy Information Element (IE), the mmWave usage policy IE comprising the at least one mmWave link usage condition field.

16. The apparatus of claim 1, wherein the frame comprises an mmWave policy request frame.

17. The apparatus of claim 1 comprising a radio to transmit the frame from the non-AP MLD.

18. The apparatus of claim 17 comprising one or more antennas connected to the radio, and a processor to execute instructions of an operating system of the non-AP MLD.

19. A product comprising one or more tangible computer-readable non-transitory storage media comprising instructions operable to, when executed by at least one processor, enable the at least one processor to cause a non Access Point (AP) (non-AP) Multi-Link Device (MLD) to:
set at least one millimeter Wave (mmWave) link usage condition field to indicate mmWave link usage condition information for Multi-Link (ML) Operation (MLO) over an mmWave link and a sub 10 Gigahertz (GHz) (sub-10 GHz) link with an AP MLD, wherein the mmWave link usage condition information is configured to indicate one or more conditions for the AP MLD to use the mmWave link to transmit one or more transmissions to the non-AP MLD; and
transmit a frame to the AP MLD, the frame comprising the at least one mmWave link usage condition field.

20. The product of claim 19, wherein the mmWave link usage condition information is configured to restrict usage of the mmWave link by the AP MLD according to the one or more conditions.
